(19) United States
(12) Patent Application Publication
(10) Pub. No.: US 2025/0139960 A1
(43) Pub. Date: May 1, 2025

(54) IMAGE RECOGNITION METHOD AND SYSTEM BASED ON MULTI-POPULATION ALTERNATE EVOLUTION NEURAL ARCHITECTURE SEARCH

(71) Applicant: Xiangtan University, Xiangtan (CN)

(72) Inventors: Juan Zou, Xiangtan (CN); Han Chu, Xiangtan (CN); Yizhang Xia, Xiangtan (CN); Li Jia, Xiangtan (CN); Yuan Liu, Xiangtan (CN); Zhanglu Hou, Xiangtan (CN); Qi Deng, Xiangtan (CN); Chang Liang, Xiangtan (CN)

(21) Appl. No.: 19/009,930

(22) Filed: Jan. 4, 2025

(30) Foreign Application Priority Data
Jan. 24, 2024 (CN) 202410095592.3

(51) Int. Cl. G06V 10/82; G06V 10/70; G06V 10/774; G06V 10/776

(52) U.S. Cl. CPC G06V 10/82; G06V 10/774; G06V 10/776; G06V 10/87

(57) ABSTRACT

Disclosed in the present invention are an image recognition method and system based on multi-population alternate evolution neural architecture search. The image recognition method includes: acquiring image data and determining a search network according to a target task; constructing a supernet and pre-training the supernet according to preset parameters; dividing a network structure search space into L sub-spaces through an L-layer structure of a neural network, and randomly selecting N candidate sub-networks from the sub-spaces to form L initialized populations; sampling multiple populations from the multiple search sub-spaces for alternate evolution, selecting frontier individuals from a merged populations in a multi-objective environment to generate a next parent population for multi-population alternate evolution; and obtaining an optimal neural network model for image recognition. The method and system realize module diversification at lower search costs, significantly reduce the complexity of the search space, and improve search efficiency.

### FIELD OF TECHNOLOGY

The present invention pertains to the technical field of image recognition, and particularly relates to an image recognition method and system based on multi-population alternate evolution neural architecture search.

### BACKGROUND

Analysis of image datasets is an emerging interdisciplinary field that requires expertise in computer vision and various fields, posing significant challenges for beginners in computer vision or specialized fields. Particularly, analyzing multiple datasets with different modalities can be unfriendly due to the non-standard nature of datasets. Previously, deep learning has dominated research and applications in image analysis, but the constant adjustment of deep learning models is costly in terms of labor and finances. Therefore, automated image classification has become increasingly important.

Currently, the technological approach of automated machine learning is adopted, using neural network search (NAS) to process image datasets. NAS is a method that automatically searches for and optimizes neural network structures using machine learning techniques. NAS aims to improve the efficiency or performance of deep learning models by searching better neural networks. The design of the search space in NAS is a key element that plays a crucial role in determining the optimal configuration.

One strategy of NAS is to explore all possible combinations of nodes and connections within neural networks, while another strategy includes: dividing the network into basic units and constructing more complex networks by stacking these units together.

Considering the scalability of the search space, the strategic methods of NAS require a substantial amount of computational resources and time. Although the second strategy reduces the complexity of the search and enhances structural adaptability, the stacking structure based on units harms the diversity of the network structure and does not fully consider the characteristics and limitations of each part of the entire network. When attempting to enhance the diversity of the network structure, it seems inevitable to incur additional search costs, presenting certain limitations.

The patent with the publication number CN 109299142 A discloses a method for searching a convolutional neural network structure based on an evolutionary algorithm, including: inputting a dataset and setting preset parameters to obtain an initial population; pushing, by a controller TC as the main thread, the initial population into a queue Q and activating a queue manager TQ and a message manager TM; after the queue manager TQ is activated, popping out untrained chromosomes from the queue Q for decoding, and then activating a worker manager TW as an independent temporary thread for training and calculating the fitness; and completing the parallel search of the convolutional neural network structure based on the evolutionary algorithm through the collaboration of the controller TC, the queue manager TQ, the worker manager TW, and the message manager TM, and outputting the best model. However, when analyzing multiple image datasets with different modalities, the complexity of the search space is high, and the search efficiency of this method needs further improvement.

### SUMMARY

In response to the above technical issues, the purpose of the present invention is to provide an image recognition method and system based on multi-population alternate evolution neural architecture search. This method not only benefits from an expandable network structure but also allows searching different layer structures without incurring additional costs, efficiently searching excellent image recognition network models for image recognition.

The technical solution of the present invention is as follows.

An image recognition method based on multi-population alternate evolution neural architecture search, including the following steps:

S01: Acquire image data and determine a search network according to a target task;

S02: Construct a supernet and pre-train the supernet according to preset parameters;

S03: Divide a network structure search space into multiple sub-spaces through an L-layer structure of a neural network, and randomly select N candidate sub-networks from the sub-spaces to form an initialized population;

S04: Sample multiple populations from the multiple search sub-spaces for alternate evolution, and select frontier individuals from a merged population in a multi-objective environment to generate the next parent population for multi-population alternate evolution; and

S05: Obtain an optimal neural network model for image recognition.

In a preferred technical solution, a method for constructing a supernet in step S02 includes:

The entire search space pool A is represented as a directed acyclic graph (DAG) of L layers, denoted by the formula: Πₗ₌^{L}Eₗ, where Eₗ represents available operations in the l^{th} layer of the DAG. The neural network within the search space is denoted by: a=Πₗ₌₁^{L}eₗ, where eₗ⊆Eₗ.

Each layer eₗ of the neural network a is composed of multiple operations {opₖ} selected from K candidate operations, denoted as:

e=o_{g}={opₖ|gₖ=1,k ϵ{1, . . . , K}}, where g represents a specific set of operation configurations {gₖ} and the binary gate gₖϵ{0,1} represents whether the k^{th} operation is selected. The number of selected operations in og is denoted as: Σₖ₌₁^{K}gₖ and the number of possible operation combinations is 2^{K}. The total number of operations contained in the L-layer neural network is: (2^{K})^{L}.

In a preferred technical solution, the supernet is pre-trained through uniform sampling of sub-network structures for training. Each sub-network structure in the supernet S is denoted by sᵢ. The weights W_{S}(Sᵢ) of the sub-network structure are inherited from the supernet weights W_{S}. The optimization of the supernet weights Wₛ is denoted as:

$${W}_{s} = arg min {E}_{{s}_{i} ∼ {U}_{S}} [ {L}_{C} ( N ( {s}_{i} , {W}_{S} ( {s}_{i} ) ) ) ]$$

Where E [·] represents the expectation, L_{C}(·) represents the cross-entropy loss, N(sᵢ, Wₛ(sᵢ)) represents the network with sub-network structure sᵢ and weights Wₛ(Sᵢ), Sᵢ˜Uₛ indicates that the sub-network sᵢ is sampled from the supernet space S, which follows a uniform distribution Uₛ.

The minimization of the expectation value E[·] is achieved by sampling the sub-network structure sᵢ from the supernet space S and then updating the corresponding weights Wₛ(sᵢ) using a stochastic gradient descent method.

In a preferred technical solution, the genetic codes of individuals in the initialized population in step S03 are denoted by a V×E matrix, where V={vᵢ}_{i=1:M} represents the set of data nodes in each layer of the neural structure, with M indicating the number of data nodes in each layer of the network; and E={vᵢ,vⱼ}_{i,j=1:M} is the set of an edge for describing connections between data nodes across layers, where the edge for the connections between data nodes indicates an operational action. The value corresponding to (vᵢ,vⱼ) in the matrix indicates the operational code value of the edge for the connections between data nodes vᵢ and vⱼ.

In a preferred technical solution, the multi-population alternate evolution in step S04 includes:

S41: Generate a current offspring population Qₗ according to preset crossover and mutation parameters as well as offspring generation strategies;

S42: Migrate excellent individuals from other populations to a current evolution population to obtain a migrated population Mₗ; and

S43: Merge the parent population Pₗ, the offspring population Qₗ, and the migrated population Mₗ to form a merged population, decode individuals within the merged population into corresponding sub-network structures sᵢ, inherit the weights Wₛ(sᵢ) from the supernet S, and then conduct fine-tuning training on the training dataset followed by an evaluation of accuracy performance indexes.

In a preferred technical solution, the fine-tuning training process of the sub-network structure sᵢ is a process of updating the weights of the supernet; given a multi-population pops, a process of sampling a complete sub-network structure sᵢ from the supernet S is implemented by sampling individuals p from the multi-population pops. The sampling process of the sub-network structure sᵢ is as follows:

$$S = {\sum }_{l ∈ L} {S}_{i}^{l} = {\sum }_{l ∈ L} decode ( {p}_{i}^{l} )$$

Where [symbol] represents an index set of the number of layers in the [symbol] -layer sub-network, and also represents [symbol] populations, decode( ) is a decoding function, and pᵢ^{l} represents individual pᵢ sampled from the l^{th} population.

In a preferred technical solution, the method for obtaining a migrated population Mₗ in step S42 includes:

Maintain migration archives, select excellent individuals from the contemporary population into the migration archive set according to the multi-objective evolutionary algorithm;

Determine the number of migrated individuals according to the adjacent distance of each population;

Select the migrated individuals of the population according to the degree of similarity between the individual and the population. The degree of similarity between individual Genₐ in population Pₐ and population P_{b} is represented by the following formula:

$$Sim ( {Gen}_{a} , {P}_{b} ) = \frac{{\sum }_{i = 1}^{D} {Gen}_{a} \times {Gen}_{b}^{i}}{D \cdot Len ( Gen )}$$

Where D represents the number of best individuals selected; Gen_{b}ⁱ represents the genetic code of the i^{th} best individual in population P_{b}, Len(Gen) is the length of the genetic code; Genₐ×Gen_{b}ⁱ is the sum of the products of the values of genes of two individuals at the corresponding bits, representing the degree of similarity between the two individuals; and Sim(Genₐ,P_{b}) is used to determine the degree of similarity between individual Genₐ and population P_{b}.

The present invention also discloses an image recognition system based on multi-population alternate evolution neural architecture search includes:

an image acquisition module, configured to acquire image data and determine a search network according to a target task;

a supernet constructing and training module, configured to construct a supernet and pre-train the supernet according to preset parameters;

an initialization module, configured to divide a network structure search space into multiple sub-spaces through an L-layer structure of a neural network, and randomly select N candidate sub-networks from the sub-spaces to form an initialized population;

a multi-population alternate evolution module, configured to sample multiple populations from the multiple search sub-spaces for alternate evolution, and select frontier individuals from a merged population in a multi-objective environment to generate the next parent population for multi-population alternate evolution; and

an image recognition module, configured to obtain an optimal neural network model for image recognition.

In a preferred technical solution, the multi-population alternate evolution in the multi-population alternate evolution module includes:

S41: Generate a current offspring population Qₗ according to preset crossover and mutation parameters as well as offspring generation strategies;

S42: Migrate excellent individuals from other populations to a current evolution population to obtain a migrated population Mₗ; and

S43: Merge the parent population Pₗ, the offspring population Qₗ, and the migrated population Mₗ to form a merged population, decode individuals within the merged population into corresponding sub-network structures sᵢ, inherit the weights Wₛ(sᵢ) from the supernet S, and then conduct fine-tuning training on the training dataset followed by an evaluation of accuracy performance indexes.

The present invention also discloses a computer storage medium on which a computer program is stored. When the computer program is executed, the above image recognition method based on multi-population alternate evolution neural architecture search is implemented.

Compared with the prior art, the present invention has the following beneficial effects.

1. The method not only benefits from an extensible network structure but also allows the searching of different layer structures without incurring additional costs to search excellent image recognition network models for image recognition.

2. The method defines the entire search space as multiple independent cell spaces, conducts searches sequentially within these cell spaces, meets the diversified needs of modules at a smaller search cost, and finds a balance between search cost and cell diversity. By simplifying the search space according to multiple populations and evenly dividing lengthy network codes into each population, the search space required for a single image dataset is reduced. The module diversification is realized at a smaller search cost, the complexity of the search space is significantly reduced, and the automated processing of image analysis is promoted.

3. Additionally, the method introduces a population migration mechanism, leveraging the knowledge and experience retained by each population to accelerate the evolutionary process, significantly speeding up the convergence rate of the populations.

### BRIEF DESCRIPTION OF THE DRAWINGS

The present invention will be further described below with reference to the accompanying drawings and examples:

FIG. 1 is a flowchart of an image recognition method based on multi-population alternate evolution neural architecture search according to an example;

FIG. 2 is a functional block diagram of an image recognition system based on multi-population alternate evolution neural architecture search according to an example;

FIG. 3 is a workflow diagram of an image recognition system based on multi-population alternate evolution neural architecture search according to an example;

FIG. 4 is a flowchart of a medical image recognition method based on multi-population alternate evolution neural architecture search according to an example; and

FIG. 5 is a flowchart of a car image recognition method based on multi-population alternate evolution neural architecture search according to an example.

### DESCRIPTION OF THE EMBODIMENTS

To make the objectives, technical solutions, and advantages of the present invention more clear and understandable, the present invention is further described in detail below with reference to specific implementations and the accompanying drawings. It should be understood that these descriptions are exemplary and are not intended to limit the scope of the present invention. Furthermore, in the following description, descriptions of well-known structures and technologies are omitted to avoid unnecessarily confusing the concepts of the present invention.

### Example 1

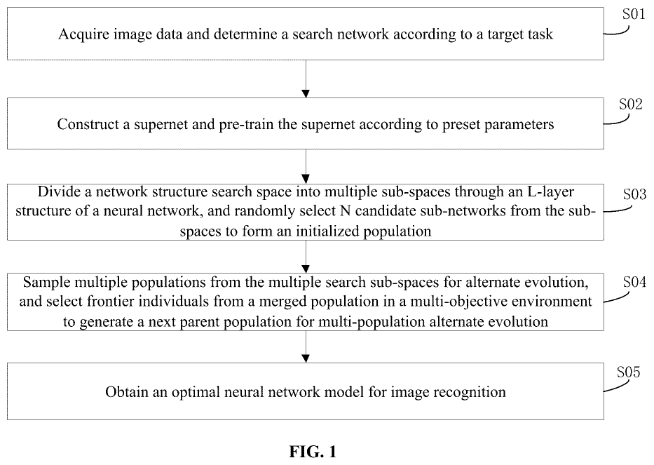

As shown in FIG. 1, an image recognition method based on multi-population alternate evolution neural architecture search includes the following steps:

S01: Acquire image data and determine a search network according to a target task;

S02: Construct a supernet and pre-train the supernet according to preset parameters;

S03: Divide a network structure search space into multiple sub-spaces through an L-layer structure of a neural network, and randomly select N candidate sub-networks from the sub-spaces to form an initialized population;

S04: Sample multiple populations from the multiple sub-spaces for alternate evolution, and select frontier individuals from a merged population in a multi-objective environment to generate the next parent population for multi-population alternate evolution; and

S05: Obtain the optimal neural network model for image recognition.

Specifically, in step S01, preset parameters can also be set, which include dataset-related parameters, network training-related parameters, and search algorithm-related parameters.

The dataset-related parameters include: a) the division ratio of a training set and a validation set; b) the batch size of the training set; c) the batch size of the validation set.

The network training-related parameters include: a) learning rate; b) gradient clipping rate for weights; c) weight decay rate; d) number of pre-training epochs for the supernet; e) total number of training epochs for the supernet; and f) number of fine-tuning training epochs for individuals in the population during the evolution.

The search algorithm-related parameters include: a) the number of populations L′; b) the population size N′; c) the maximum number of iterations T; d) the individual gene crossover rate; e) the individual gene mutation rate; and f) the size of the migration archive set.

In an optimal example, the method for constructing a supernet in step S02 includes:

The entire search space pool A is represented as a directed acyclic graph (DAG) of L layers, denoted by the formula: Πₗ₌₁^{L}E, where Et represents available operations in the l^{th} layer of the DAG. The neural network within the search space is denoted by: a=Πₗ₌₁^{L}eₗ, where eₗ⊆Eₗ.

Each layer eₗ of the neural network is composed of multiple operations {opₖ} selected from K candidate operations, denoted as e=o_{g}={opₖ|gₖ=1,k ∈{1, . . . ,K }}, where g represents a specific set of operation configurations {gₖ} and the binary gate gₖ∈{0,1} represents whether the k^{th} operation is selected. The number of selected operations in o_{g} is denoted as: Σₖ₌₁^{K}gₖ and the number of possible operation combinations is 2^{K}. The total number of operations contained in the L-layer neural network is: (2^{K})^{L}.

In a preferred example, the supernet is pre-trained through uniform sampling of sub-network structures for training. Each sub-network structure in the supernet S is denoted by Sᵢ. The weights Wₛ(sᵢ) of the sub-network structure are inherited from the supernet weights Wₛ. The optimization of the supernet weights Wₛ is denoted as:

$${W}_{s} = arg min {E}_{{s}_{i} ∼ {U}_{S}} [ {L}_{C} ( N ( {s}_{i} , {W}_{S} ( {s}_{i} ) ) ) ]$$

Where E[·] represents the expectation, L_{c}(·) represents the cross-entropy loss, N(sᵢ, Wₛ(sᵢ)) represents the network with sub-network structure sᵢ and weights Wₛ(sᵢ), Sᵢ˜Uₛ indicates that the sub-network sᵢ is sampled from the supernet space S, which follows a uniform distribution Uₛ.

The minimization of the expectation value E[·] is achieved by sampling the sub-network structure sᵢ from the supernet space S and then updating the corresponding weights Wₛ(sᵢ) using a stochastic gradient descent method.

In a preferred example, the genetic codes of individuals in the initialized population in step S03 are denoted by a V×E matrix, where V={viᵢ}_{i=1:M} represents the set of data nodes in each layer of the neural structure, with M indicating the number of data nodes in each layer of the network; and E={vᵢ,vⱼ}_{i,j=1:M} is the set of an edge for describing connections between data nodes across layers, where the edge for the connections between data nodes indicates an operational action (such as convolution, pooling and other operations). The value corresponding to (vᵢ,vⱼ) in the matrix indicates the operational code value of the edge for the connections between data nodes vᵢ and vⱼ.

In a preferred example, the multi-population alternate evolution in step S04 includes:

S41: Generate a current offspring population Qₗ according to preset crossover and mutation parameters as well as offspring generation strategies;

S42: Migrate excellent individuals from other populations to a current evolution population to obtain a migrated population Mₗ; and

S43: Merge the parent population Pₗ, the offspring population Qₗ, and migrated population Mₗ to form a merged population, decode individuals within the merged population into corresponding sub-network structures sᵢ, inherit the weights Wₛ(sᵢ) from the supernet S, and then conduct fine-tuning on the training dataset followed by an evaluation of accuracy performance indexes.

In a preferred example, the fine-tuning training process of the sub-network structure Sᵢ is a process of updating the weights of the supernet; given a multi-population pops, a process of sampling a complete sub-network structure sᵢ from the supernet S is implemented by sampling individuals p from the multi-population pops. The sampling process of the sub-network structure sᵢ is as follows:

$$S = {\sum }_{l ∈ L} {S}_{i}^{l} = {\sum }_{l ∈ L} decode ( {p}_{i}^{l} )$$

Where [symbol] represents an index set of the number of layers in the [symbol] -layer sub-network, and also represents [symbol] populations, decode ( ) is a decoding function, and pᵢ^{l} represents individual pᵢ sampled from the l^{th} population.

In a preferred example, the method for obtaining a migrated population Mₗ in step S42 includes:

Maintain migration archives, and select excellent individuals from the contemporary population into the migration archive set according to the multi-objective evolutionary algorithm;

Determine the number of migrated individuals according to the adjacent distance of each population;

Select the migrated individuals of the population according to the degree of similarity between the individual and the population. The degree of similarity between individual Genₐ in population Pₐ and population P_{b} is represented by the following formula:

$$Sim ( {Gen}_{a} , {P}_{b} ) = \frac{{\sum }_{i = 1}^{D} {Gen}_{a} \times {Gen}_{b}^{i}}{D \cdot Len ( Gen )}$$

Where D represents the number of best individuals selected; Gen_{b}ⁱ represents the genetic code of the i^{th} best individual in population P_{b}, Len(Gen) is the length of the genetic code; Genₐ×Gen_{b}ⁱ is the sum of the products of the values of genes of two individuals at the corresponding bits, representing the degree of similarity between the two individuals; and Sim(Genₐ,P_{b}) is used to judge the degree of similarity between individual Genₐ and population P_{b}.

In another example, a computer storage medium on which a computer program is stored. When the computer program is executed, the above image recognition method based on multi-population alternate evolution neural architecture search is implemented. The specific method is consistent with the image recognition method based on multi-population alternate evolution neural architecture search described above, which will not be repeated here.

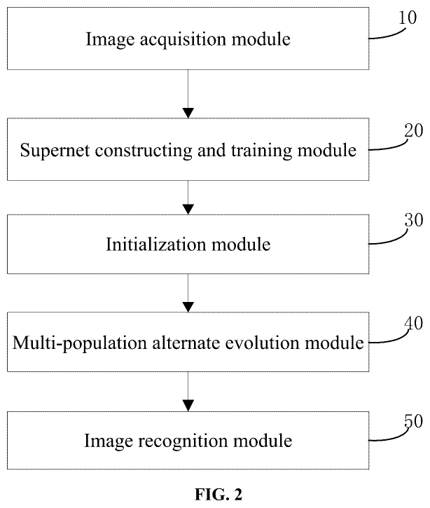

In another example, as shown in FIG. 2, an image recognition system based on multi-population alternate evolution neural architecture search includes:

an image acquisition module 10, configured to acquire image data and determine a search network according to a target task;

a supernet constructing and training module 20, configured to construct a supernet and pre-train the supernet according to preset parameters;

an initialization module 30, configured to divide a network structure search space into multiple sub-spaces through an L-layer structure of a neural network, and randomly select N candidate sub-networks from the sub-spaces to form an initialized population;

a multi-population alternate evolution module 40, configured to sample multiple populations from the multiple search sub-spaces for alternate evolution, and select frontier individuals from a merged population in a multi-objective environment to generate the next parent population for multi-population alternate evolution; and

an image recognition module 50, configured to obtain an optimal neural network model for image recognition.

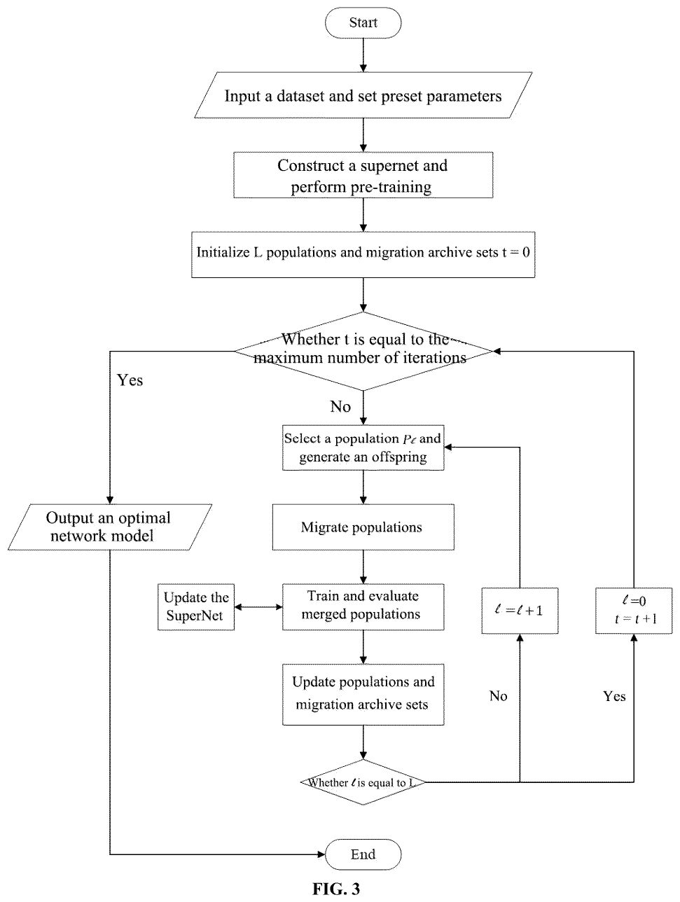

The workflow of the image recognition system based on multi-population alternate evolution neural architecture search is described in detail below with a best example,, as shown in FIG. 3, including the following steps.

Step 1: Input the dataset and set preset parameters.

Step 2: Construct the supernet and perform pre-training: perform pre-training on the supernet according to preset parameters.

Step 3: Initialize multiple populations and migration archive sets: initialize multiple populations and migration archive sets according to preset parameters.

Loop Judgment \textcircled{1}: Enter the multi-population alternate evolution phase and perform T multi-population alternate evolution cycles according to the preset maximum number of iterations. At the same time, determine whether the current number of iterations t has reached the maximum number of iterations T. If so, proceed to Step 9 to output the optimal network structure and end. Otherwise, select population Pₗ to start the single-population evolution process.

Step 4: Generate offsprings. Select the current population Pₗ to be evolved, and generate the current offspring population Qₗ according to the preset crossover and mutation parameters as well as the offspring generation strategy.

Step 5: Migrate populations. According to the population migration mechanism, migrate excellent individuals from other populations to the current evolution population to obtain a migrated population Mₗ.

Step 6: Train and evaluate merged populations. Evaluate the network individuals in the parent population Pₗ, the offspring population Qₗ, and the migrated population Mₗ according to the weight inheritance strategy.

Step 7: Update supernet. Synchronously update the weight parameters of the supernet during the training of individuals in the population in Step 6.

Step 8: Update populations and migration archive sets. If the preset termination generation is met, proceed to Step 9; otherwise, return to Step 4.

Loop Judgment \textcircled{2}: Determine whether the multi-population alternate evolution process of the current t^{th} generation has ended. If so, proceed to the t+1 generation multi-population alternate evolution process; otherwise, select the next population Pₗ₊₁ in sequence for single-population evolution process.

Step 9: Output the optimal network model and end.

The preset parameters in Step 1 include dataset-related parameters, network training-related parameters, and search algorithm-related parameters.

The dataset-related parameters include: a) the division ratio of a training set and a validation set; b) the batch size of the training set; c) the batch size of the validation set.

The network training-related parameters include: a) learning rate; b) gradient clipping rate for weights; c) weight decay rate; d) number of pre-training epochs for the supernet; e) total number of training epochs for the supernet; f) number of fine-tuning training epochs for individuals during the evolutionary.

The search algorithm-related parameters include: a) the number of populations L; b) the population size N′; c) the maximum number of iterations T; d) the individual gene crossover rate; e) the individual gene mutation rate; f) the size of the migration archive set.

The construction of the supernet in step 2 is to construct a larger network SuperNet including all predefined operations. Since neural architectures typically use feedforward structures, in this example, the entire search space pool A is represented as a directed acyclic graph (DAG) of L layers, denoted by the formula Πₗ₌₁^{L}Eₗ, where Eₗ represents available operations in the l^{th} layer of the DAG (such as convolution, pooling, and other operations). Therefore, the neural network within the search space is denoted by a=Πₗ₌₁^{L}eₗ, where eₗ⊆Eₗ. Each layer eₗ of the neural network a is composed of multiple operations {opₖ} selected from K candidate operations, denoted as: e=o={opₖ|gₖ=1,k ∈{1, . . . , K}}, where g represents a specific set of operation configurations {gₖ} and the binary gate gₖ ∈ {0,1} represents whether the k^{th} operation is selected. In this case, the number of selected operations in o_{g} is denoted as: Σₖ₌₁^{K}gₖ and the number of possible operation combinations is 2^{K}, while the total number of operations contained in the L-layer neural network is: (2^{K})^{L}.

In Step 2, the supernet is pre-trained through uniform sampling of sub-network structures for training. Each sub-network structure in the supernet S is denoted by sᵢ, and the weights Wₛ(sᵢ) of the sub-network structure are inherited from the supernet weights Wₛ. The optimization of the supernet weights Wₛ is denoted as:

$${W}_{s} = arg min {E}_{{s}_{i} ∼ {U}_{S}} [ {L}_{C} ( N ( {s}_{i} , {W}_{S} ( {s}_{i} ) ) ) ] \qquad Formula 1$$

Where E[·] represents the expectation, L_{c}(·) represents the cross-entropy loss, N(sᵢ, Wₛ(sᵢ)) represents the network with sub-network structure Sᵢ and weights Wₛ(sᵢ), and Sᵢ˜U_{S} indicates that the sub-network sᵢ is sampled from the supernet space S, which follows a uniform distribution U_{S}. The minimization of the expectation value E[·] is achieved by sampling the sub-network structures sᵢ from the supernet space S and then updating the corresponding weights Wₛ(sᵢ) using a stochastic gradient descent method. In the example, uniform sampling is performed for each possible architecture, and the sampling probability for the sub-network structure follows pi˜Bernoulli (0.5), where Bernoulli ( ) is the Bernoulli distribution.

In Step 3, the initialization of L populations indicates the sub-network sampling encoding for each layer of the L-layer neural network. According to the L-layer structure of the neural network, the search space A is divided into L subset spaces Aₗ. Then, N candidate sub-networks are randomly selected from each sub-space Aₗ to form a population. The genetic codes of individuals in the population are denoted by a V×E matrix, where V={vᵢ}_{i=1:M} represents the set of data nodes in each layer of the neural structure, with M indicating the number of data nodes in each layer of the network; E={vᵢ,vⱼ}_{i,j=1:M} is the set of an edge for describing connections between data nodes across layers, where the edge for the connections between data nodes indicates an operational action (such as convolution, pooling, and other operations), and the values corresponding to (Vᵢ, Vⱼ) in the matrix indicates the operation code values of the edge for the connections between the data nodes vᵢ and vⱼ.

The initialization of the migration archive set is to randomly select m excellent individuals to form the migration archive set Mₗ for population Pₗ.

In Step 4, offspring generation is achieved through three operational operators: selection, crossover, and mutation. The operational operators are selected to select excellent individuals according to the fitness values of the previous evolution for crossover and mutation, thus generating offsprings. The selected strategies are optionally one of three methods of roulette wheel selection, tournament selection, and probabilistic selection. The crossover method can be either single-point crossover or multi-point crossover. Single-point crossover is that two parent individuals select the same point in the binary encoding genes for crossover to produce two entirely new offspring individuals, while multi-point crossover is to select multiple points for crossover. Mutation is to select multi-point mutation.

According to the mutation probability in the preset parameters in Step 1, it is determined whether the binary needs to mutate from 0 to 1 or from 1 to 0. The current population popₗ undergoes the process of selection, crossover, and mutation repeatedly until the predefined maximum number of offspring is reached, at which point the process ends, obtaining the current offspring population Qₗ.

In Step 5, the population migration mechanism consists of three aspects: maintaining migration archives (Step 8), determining the number of migrated individuals for each population, and selecting migrated individuals (Step 5). The migration mechanism determines the number of migrated individuals according to the adjacent distance of each population. The adjacent distance between the populations is the difference between the network layer numbers corresponding to each population. At the same time, the migrated individuals of the population are selected according to the degree of similarity between the individual and the population. The degree of similarity between individual Genₐ in population Pₐ and population P_{b} is represented by the following formula:

$$Sim ( {Gen}_{a} , {P}_{b} ) = \frac{{\sum }_{i = 1}^{D} {Gen}_{a} \times {Gen}_{b}^{i}}{D \cdot Len ( Gen )} \qquad Formula 2$$

Where D represents the number of best individuals selected; Gen_{b}ⁱ represents the genetic code of the i^{th} best individual in population P_{b}; Genₐ×Gen_{b}ⁱ is the sum of the products of the values of genes of two individuals at the corresponding bits, and representing the degree of similarity between the two individuals, and Len(Gen) is the length of the genetic code; and Sim(Genₐ,P_{b}) is used to judge the degree of similarity between individual Genₐ and population P_{b}. The smaller the value of Sim(Genₐ,P_{b}), the lower the degree of similarity between the selected migration individual Genₐ from population Pₐ and population P_{b}, with the aim of increasing the diversity of population P_{b} while ensuring the individual's fitness.

In Step 6, the training of the merged population and the weight update of the supernet in Step 7 are conducted alternately. The merged population refers to merging the parent population Pₗ, the offspring population Qₗ, and the migrated population Mₗ to form a population Cₗ, denoted by Cₗ=Pₗ υQₗυMₗ. The individuals in the merged population Cₗ are first decoded into the corresponding sub-network structures si and inherit the weights Wₛ(sᵢ) from the supernet S. After that, they undergo a small number of epochs of fine-tuning training on the training dataset Dₜᵣₐᵢₙ, followed by an evaluation of accuracy performance indexes on the validation dataset D_{vaild}. The fine-tuning training process of the sub-network structure Si is the weight update process of the supernet, and its optimization process is the same as the formula 1 in Step 2. The process of sampling a complete sub-network structure sᵢ from the supernet S for a given multi-population pops is achieved by sampling individuals p from the multi-population pops. The sampling process of the sub-network structure Sᵢ can be defined as follows:

$$S = {\sum }_{l ∈ L} {S}_{i}^{l} = {\sum }_{l ∈ L} decode ( {p}_{i}^{l} ) \qquad Formula 3$$

Where [symbol] represents an index set of the number of layers in the [symbol] -layer sub-network, and also represents [symbol] populations. pᵢ^{l} represents individual pᵢ sampled from the l^{th} population.

In Step 8, population updating is achieved through the multi-objective evolutionary algorithm NSGA-III. From the merged population Cₗ, the NSGA-III algorithm and at least two optional predefined objectives (accuracy, number of model parameters, FLOPS) are used to select a predefined number N of individuals as the next generation's parent population.

The update of the migration archive set is also to select excellent individuals from the current population according to the multi-objective evolutionary algorithm to enter the migration archive set and cover the previous individuals.

After completing Step 8, it is determined whether the preset number of termination generations has been reached. If yes, Step 9 is proceeded to output the optimal network model; otherwise, Step 4 is returned.

In the example, comparative experimental results on the CIFAR dataset with other algorithms are provided, as shown in Table 1 below. In the example, the CIFAR-10 and CIFAR-100 training sets are divided into two parts, with 25,000 images used for the training dataset Dₜᵣₐᵢₙ and 25,000 images for the validation dataset D_{vaild}. A total of 500 epochs were searched, with the supernet parameter preheating phase lasting for the first 10% of the period (50 epochs).

TABLE 1
Comparative Experimental Results on the CIFAR Dataset

| | CIFAR 10 | | | CIFAR 100 | | |
|---|---|---|---|---|---|---|
| Algorithm model | ACC(%) | # P(M) | GDs | ACC(%) | # P(M) | GDs |
| AmoebaNet-A | 96.66 ± 0.06 | 3.1 | 3150 | 81.07 | 3.1 | 3150 |
| CNN-GA | 96.78 | 2.9 | 35 | 79.47 | 4.1 | 40 |
| AE-CNN | 95.3 | 2 | 27 | 77.6 | 5.4 | 36 |
| AE-CNN + E2EPP | 94.7 | 4.3 | 7 | 77.98 | 20.9 | 10 |
| NASNet-A | 97.35 | 3.2 | 1800 | 82.19 | 3.2 | 1800 |
| BlockQNN-S | 96.7 | 6.1 | 90 | 82.95 | 6.1 | 90 |
| PNAS | 96.59 ± 0.09 | 3.2 | 225 | 82.37 | 3.2 | 225 |
| MdeNAS | 97.45 | 3.8 | 0.16 | 82.39 | 3.8 | 0.16 |
| RENAS | 97.12 ± 0.02 | 3.5 | 6 | — | — | — |
| GDAS-NSAS | 97.25 ± 0.08 | 3.5 | 0.4 | 81.98 ± 0.05 | 3.5 | 0.4 |
| ENAS | 97.11 | 4.6 | 0.5 | 81.09 | 4.6 | 0.5 |
| WPL | 96.19 | — | — | — | — | — |
| Random (F = 64) | 95.6 | 6.7 | — | — | — | — |
| RandomNAS-NSAS | 97.41 ± 0.05 | 3.1 | 0.7 | 82.44 ± 0.05 | 3.1 | 0.7 |
| SNAS | 97.15 ± 0.02 | 2.8 | 1.5 | 79.91 | 2.8 | 1.5 |
| PDARTS | 97.5 | 3.4 | 0.3 | 84.08 | 3.6 | 0.3 |
| PC-DARTS | 97.43 ± 0.07 | 3.6 | 0.1 | 82.89 | 3.6 | 0.1 |
| DARTS | 97.00 ± 0.14 | 3.3 | 1 | 82.46 | 3.3 | 1 |
| CARS | 97.38 | 3.6 | 0.4 | 82.72 | 3.6 | 0.4 |
| MPAE-A | 97.35 | 2.8 | 0.4 | 82.74 | 2.9 | 0.4 |
| MPAE-B | 97.39 | 3.2 | 0.4 | 83.45 | 3.3 | 0.4 |
| MPAE-C | 97.51 | 3.7 | 0.4 | 84.12 | 3.6 | 0.4 |

From the table, it can be seen that the optimal model searched by the method of this example on the CIFAR-10 and CIFAR-100 datasets achieves highly competitive results in both model accuracy (ACC) and search time (GDs), outperforming most competitors. On the CIFAR-10 and CIFAR-100 datasets, the optimal network model MPAE-C found by the algorithm has a classification accuracy of up to 97.51% and 84.12%, respectively, surpassing all peer competitors considered in the experiment; and the search cost only requires 0.4 GDs, which is far less than the computational resources consumed by the AmoebaNet-A and NASNet-A models (0.4 GDs«3150 GDs, 0.4 GDs «1800 GDs).

### Example 2

The automated search and classification of medical images face has the problems of unfriendly analysis and difficulty in mastering. The current algorithms are often very costly and consume more human and financial resources. The image recognition method based on multi-population alternate evolution neural architecture search of the present invention is applied to the automated search and classification of medical images, and can automatically search an excellent medical image recognition network model from the sampling dataset to solve the problems.

By utilizing a collection of publicly available medical open datasets, standardized medical image processing-related sampling data is obtained. The sampling dataset includes MedMNIST, which consists of 10 pre-processed datasets from selected sources, and covers major data forms (X-ray, OCT, ultrasound, CT), various classification tasks (binary/multi-class, ordinal regression, and multi-label), and data scales (ranging from 100 to 100,000).

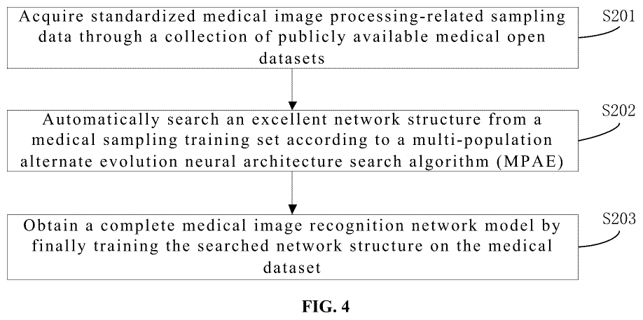

Based on the above content, the flowchart of the multi-population alternate evolution search algorithm provided in this example for the recognition process in the field of medical images, as shown in FIG. 4, includes the following steps.

Step S201: Acquire standardized medical image processing-related sampling data through a collection of publicly available medical open datasets.

Step S202: Automatically search an excellent network structure from a medical sampling training set according to a multi-population alternate evolution neural architecture search algorithm (MPAE) and a supernet model, where a search process uses a multi-population to represent different modules, and each module is alternately optimized. The specific implementation mode is the same as that in Example 1.

Step S203: Obtain a complete medical image recognition network model by finally training the searched network structure on the medical dataset.

From the MedMNIST publicly available medical open dataset, the following datasets are available: PathMNIST that is a dataset for predicting survival outcomes of colorectal cancer histology slides; DermaMNIST that is a dataset of dermoscopic images of common skin pigmented lesions from multiple sources; OCTMNIST that is a dataset of effective optical coherence tomography (OCT) images related to retinal diseases; OrganMNIST {Axial, Coronal, Sagittal} that is a 3D computed tomography (CT) image dataset based on the liver tumor segmentation benchmark (LiTS); and other medical datasets.

Step S203 is to retrain the optimal network structure on the complete MedMNIST dataset (including both the training set and the test set) to obtain the accurate network model weight parameters and the final recognition accuracy results. The comparison of the final experimental results with the experimental results of other algorithms is shown in Table 2 below.

TABLE 2
Comparison of MPAE with other benchmark methods on the
MedMNIST series dataset in terms of accuracy (%)

| Network | Path | Derma | OCT | O-A | O-C | O-S |
|---|---|---|---|---|---|---|
| ResNet18 | 86 | 75 | 75.8 | 92.1 | 88.9 | 76.2 |
| ResNet50 | 84.6 | 72.7 | 74.5 | 91.6 | 89.3 | 74.6 |
| Auto-sklearn | 18.6 | 73.4 | 59.5 | 56.3 | 67.6 | 60.1 |
| AutoKeras | 86.4 | 75.6 | 73.6 | 92.9 | 91.5 | 80.3 |
| Google AutoML Vision | 81.2 | 76.1 | 73.2 | 81.6 | 86.2 | 70.7 |
| SI-EvoNAS | 90.58 | 76.66 | 78.14 | 92.98 | 91.8 | 80.14 |
| MPAE | 91.88 | 78.56 | 80.2 | 94.24 | 92.58 | 81.02 |

It can be seen from the above table that the medical image recognition network model searched by the algorithm of the present invention has high accuracy.

### Example 3

The image recognition method based on multi-population alternate evolution neural architecture search of the present invention can be applied to the automated search and classification of car images. An excellent car image recognition network model is automatically searched for the sampling dataset.

By utilizing a collection of publicly available car datasets, standardized car image processing-related sampling data is obtained. The sampling dataset includes the Stanford Cars dataset and the CompCars dataset. The Stanford Cars dataset is a fine-grained classification dataset specifically designed for car image recognition tasks, and contains images of 196 car types with 16,185 different car models, including 8,144 images for the training set and 8,041 images for the test set, covering detailed category processing, including car images of different angles, sizes and lighting conditions. The Comprehensive Cars (CompCars) dataset includes data from both web and surveillance scenarios. The web image data contains 163 car brands and 1,716 car models, with a total of 136,726 whole car images and 27,618 car part images. The surveillance image data contains 50,000 car images captured in a frontal view.

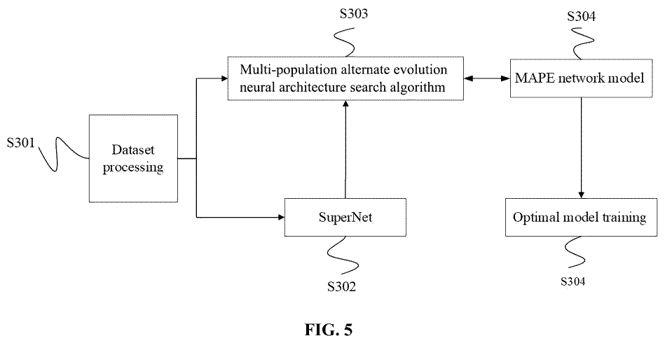

Based on the above content, the flowchart of the multi-population alternate evolution search algorithm provided in this example for the recognition process in the field of car image, as shown in FIG. 5, includes the following steps.

Step S301: Acquire the car image datasets of Stanford Cars and CompCars through a collection of publicly available car open datasets and conduct pre-processing. The pre-processing methods optionally include multiple methods of CenterCrop, Resize, Normalize and data enhancement.

Step S302: Input the car image dataset into a supernet model that includes all operators within the entire network for training to prepare for weight sharing in Step S303.

Step S303: Automatically search an excellent network structure for an inputted car sampling training set according to the multi-population alternate evolution neural architecture search algorithm (MPAE) and the supernet model. The specific implementation mode is the same as that in Example 1.

Step S304: Evaluate and iterate the neural network models MPAE continuously generated from Step S303, determine whether the maximum number of iterations has been reached; and if so, proceed to the next step, otherwise continue iterating.

Step S305: Optimal Model Training. Step S305 is to retrain the optimal network structure on the complete car dataset (including the training set and the test set) to obtain the accurate weight parameters of the network model and the final recognition accuracy result. The comparison of the final experimental results on the Stanford Cars datasets and CompCars datasets with the experimental results of other algorithms are shown in Table 3 below.

TABLE 3
Comparison of MPAE with other benchmark methods on theStanford
Cars dataset and CompCars dataset in terms of accuracy (%)

| | Stanford Cars | CompCars | |
|---|---|---|---|
| Model | Accuracy (%) | Accuracy(top1) | Accuracy(top5) |
| GoogLeNet | — | 91.2 | 98.1 |
| Overfeat | — | 87.9 | 96.9 |
| AlexNet | — | 81.9 | 94 |
| FT-HAR-CNN | 86.3 | — | — |
| Kernel-Pooling | 91.1 | — | — |
| B-CNN | 91.3 | — | — |
| MA-CNN | 92.8 | — | — |
| MPAE | 93.2 | 92.8 | 99.5 |

It can be seen from the above table that the car image recognition network model searched by the algorithm of the present invention has high accuracy.

It should be understood that the above specific examples of the present invention are merely exemplary for illustrative or explanatory purposes, and do not constitute a limitation on the present invention. Therefore, any modifications, equivalent substitutions, improvements, etc., made without departing from the spirit and scope of the present invention should be included within the scope of protection of the present invention. In addition, the claims appended to the present invention are intended to cover all variations and modifications falling within the scope and boundaries of the appended claims, or their equivalent forms.

What is claimed is:

1. An image recognition method based on multi-population alternate evolution neural architecture search, comprising the following steps:
S01: acquiring image data and determining a search network according to a target task;
S02: constructing a supernet and pre-training the supernet according to preset parameters;
S03: dividing a network structure search space into multiple sub-spaces through an L-layer structure of a neural network, and randomly selecting N candidate sub-networks from the sub-spaces to form an initialized population;
S04: sampling multiple populations from the multiple sub-spaces for alternate evolution, and selecting frontier individuals from a merged population in a multi-objective environment to generate a next parent population for multi-population alternate evolution, wherein the multi-population alternate evolution comprises:
S41: generating a current offspring population Qₗ according to preset crossover and mutation parameters as well as offspring generation strategies;
S42: migrating excellent individuals from other populations to a current evolution population to obtain a migrated population Mₗ, wherein a method for obtaining a migrated population Mₗ comprises: maintaining migration archives and selecting excellent individuals from a contemporary population into a migration archive set according to a multi-objective evolutionary algorithm;
determining the number of migrated individuals according to an adjacent distance of each population; and
selecting the migrated individuals of the population according to a degree of similarity between the individuals and the populations;
S43: merging the parent population Pₗ, the offspring population Qₗ, and the migrated population Mₗ to form a merged population, decoding the individuals within the merged population into corresponding sub-network structures sᵢ and inheriting weights Wₛ(sᵢ) from the supernet S, and then conducting fine-tuning training on a training dataset followed by an evaluation of accuracy performance indexes.
S05: obtaining an optimal neural network model for image recognition.

2. The image recognition method based on multi-population alternate evolution neural architecture search according to claim 1, wherein a method for constructing a supernet in step S02 comprises:
an entire search space pool A is represented as a directed acyclic graph of L layers, denoted by a formula: Πₗ₌₁^{L}Eₗ, wherein Eₗ represents available operations in the l^{th} layer of the directed acyclic graph, and the neural network a within the search space is denoted by: a=Πₗ₌₁^{L}eₗ, where eₗ⊆Eₗ; and each layer eₗ of the neural network is composed of multiple operations {opₖ} selected from K candidate operations, denoted as: e=o_{g}={opₖ|gₖ=1,k ∈{1, . . . , K}}, wherein g represents a specific set of operation configurations {gₖ} and a binary gate gₖ∈{0,1} represents whether the k^{th} operation is selected, the number of selected operations in o_{g} is denoted as: Σₖ₌₁^{K}gₖ the number of possible operation combinations is 2^{K}, and a total number of operations contained in the L-layer neural network is: (2^{K})^{L}.

3. The image recognition method based on multi-population alternate evolution neural architecture search according to claim 1, wherein the supernet is pre-trained through uniform sampling of sub-network structures for training, each sub-network structure in the supernet S is denoted by sᵢ, and weights Wₛ(sᵢ) of the sub-network structure are inherited from supernet weights Wₛ, and optimization of the supernet weights Wₛ is denoted as:
$${W}_{s} = arg min {E}_{{s}_{i} ∼ {U}_{S}} [ {L}_{C} ( N ( {s}_{i} , {W}_{S} ( {s}_{i} ) ) ) ]$$
Where E[·] represents expectation, L_{c}(·) denotes cross-entropy loss, N(sᵢ,Wₛ(sᵢ)) represents a network with a sub-network structure sᵢ and weights Wₛ(sᵢ), sᵢ˜Uₛ indicates that the sub-network sᵢ is sampled from the supernet space S, which follows a uniform distribution Uₛ;
minimization of the expectation value E[·] is achieved by sampling the sub-network structure sᵢ from the supernet space S and then updating corresponding weights Wₛ(sᵢ) using a stochastic gradient descent.

4. The image recognition method based on multi-population alternate evolution neural architecture search according to claim 1, wherein genetic codes of individuals in the initialized population in step S03 are denoted by a V×E matrix, wherein V={vᵢ}_{i=1:M} represents a set of data nodes in each layer of the neural structure, with M indicating the number of data nodes in each layer of the network; and E={vᵢ,vⱼ}_{i,j=1:M} is a set of an edge for describing connections between data nodes across layers, wherein the edge for the connections between the data nodes indicates an operational action, a value corresponding to (vᵢ,vᵢ) in the matrix indicates an operational code value of the edge for the connections between the data nodes vᵢ and vⱼ.

5. The image recognition method based on multi-population alternate evolution neural architecture search according to claim 1, wherein a fine-tuning training process of the sub-network structure sᵢ is a process of updating weights of the supernet; and given a multi-population pops, a process of sampling a complete sub-network structure sᵢ from the supernet S is implemented by sampling individuals p from the multi-population pops, and the sampling process for the sub-network structure sᵢ is as follows:
$$S = {\sum }_{l ∈ L} {S}_{i}^{l} = {\sum }_{l ∈ L} decode ( {p}_{i}^{l} )$$
Where [symbol] represents an index set of the number of layers in the [symbol] -layer sub-network, and also represents [symbol] populations, decode ( ) is a decoding function, and pᵢ^{l} represents individual pᵢ sampled from the ^{th} populations.

6. The image recognition method based on multi-population alternate evolution neural architecture search according to claim 1, wherein a method for calculating a degree of similarity between individuals Genₐ and populations P_{b} comprises:
the degree of similarity between individual Genₐ in population Pₐ and population P_{b} is represented by the following formula:
$$Sim ( {Gen}_{a} , {P}_{b} ) = \frac{{\sum }_{i = 1}^{D} {Gen}_{a} \times {Gen}_{b}^{i}}{D \cdot Len ( Gen )}$$
Where D represents the number of best individuals selected; Gen_{b}ⁱ represents a genetic code of the i^{th} best individual in population P_{b}, Len(Gen) is the length of the genetic code; Genₐ×Gen_{b}ⁱ is a sum of the products of values of genes of two individuals at corresponding bits, representing the degree of similarity between the two individuals; and Sim(Genₐ,P_{b}) is used to determine the degree of similarity between individual Genₐ and population P_{b}.

7. An image recognition system based on multi-population alternate evolution neural architecture search, comprising:
an image acquisition module, configured to acquire image data and determine a search network according to a target task;
a supernet construction and training module, configured to construct a supernet and pre-train the supernet according to preset parameters;
an initialization module, configured to divide a network structure search space into multiple sub-spaces through an L-layer structure of a neural network, and randomly select N candidate sub-networks from the sub-spaces to form an initialized population;
a multi-population alternate evolution module, configured to sample multiple populations from the multiple sub-spaces for alternate evolution, and select frontier individuals from a merged population in a multi-objective environment to generate a next parent population for multi-population alternate evolution, wherein the multi-population alternate evolution comprises: S41: generating a current offspring population Qₗ according to preset crossover and mutation parameters as well as offspring generation strategies;
S42: migrating excellent individuals from other populations to a current evolution population to obtain a migrated population Mₗ, wherein a method for obtaining a migrated population Mₗ comprises: maintaining migration archives and selecting excellent individuals from a contemporary population into a migration archive set according to a multi-objective evolutionary algorithm;
determining the number of migrated individuals according to an adjacent distance of each population; and
selecting the migrated individuals of the population according to a degree of similarity between individuals and populations;
S43: merging the parent population Pₗ, the offspring population Qₗ, and the migrated population Mₗ to form a merged population, decoding the individuals within the merged population into corresponding sub-network structures sᵢ and inheriting weights Wₛ(sᵢ) from the supernet S, and then conducting fine-tuning training on a training dataset followed by an evaluation of accuracy performance indexes; an image recognition module, configured to obtain an optimal neural network model for image recognition.

8. A computer storage medium on which a computer program is stored, wherein when the computer program is executed, the image recognition method based on multi-population alternate evolution neural architecture search is implemented.
